(19) United States
(12) Patent Application Publication
(10) Pub. No.: US 2024/0221441 A1
(43) Pub. Date: Jul. 4, 2024

(54) METHOD OF ESTIMATING TRAVELING SITUATION OF VEHICLE, METHOD OF GENERATING CLASSIFIER THAT ESTIMATES TRAVELING SITUATION OF VEHICLE, AND ESTIMATOR THAT ESTIMATES TRAVELING SITUATION OF VEHICLE

(71) Applicant: KAWASAKI MOTORS, LTD., Akashi-shi (JP)

(72) Inventors: Shohei HOSOKAWA, Kobe-shi (JP); Atsushi SANO, Kobe-shi (JP); Kazuya NAGASAKA, Kobe-shi (JP); Taichi INABA, Kobe-shi (JP)

(21) Appl. No.: 18/090,262

(22) Filed: Dec. 28, 2022

(51) Int. Cl. G07C 5/08

(52) U.S. Cl. CPC G07C 5/085

(57) ABSTRACT

A method of estimating a traveling situation of a vehicle includes: by at least one processor, receiving sensor values, obtained by at least one sensor mounted on the vehicle, plural times while the vehicle is traveling a traveling section; specifying which of predetermined M ranges each of the received sensor values belongs to, M being an integer of two or more; counting, as frequency values, the numbers of times of the execution of the specifying step for the respective ranges; inputting, to a classifier, the counted M frequency values respectively corresponding to the M ranges; and outputting, from the classifier, any of K types of predetermined traveling situation categories respectively indicating traveling situations of the vehicle, as a situation estimation result indicating the traveling situation of the vehicle in the traveling section, K being an integer of two or more.

### BACKGROUND OF THE INVENTION

### Field of the Invention

The present disclosure relates to a method of estimating a traveling situation of a vehicle, a method of generating a classifier that estimates the traveling situation of the vehicle, and an estimator that estimates the traveling situation of the vehicle.

### Description of the Related Art

US 2021/0019960 A1 discloses a state monitoring device that monitors a state of a vehicle.

### SUMMARY OF THE INVENTION

A method according to one aspect of the present disclosure is a method of estimating a traveling situation of a vehicle. The method includes: by at least one processor, receiving sensor values, obtained by at least one sensor mounted on the vehicle, plural times while the vehicle is traveling a traveling section; specifying which of predetermined M ranges each of the received sensor values belongs to, M being an integer of two or more; counting, as frequency values, the numbers of times of the execution of the specifying step for the respective ranges; inputting, to a classifier, the counted M frequency values respectively corresponding to the M ranges; and outputting, from the classifier, any of K types of predetermined traveling situation categories respectively indicating traveling situations of the vehicle, as a situation estimation result indicating the traveling situation of the vehicle in the traveling section, K being an integer of two or more.

An estimator according to another aspect of the present disclosure is an estimator that estimates a traveling situation of a vehicle. The estimator includes: a memory storing a computer program; and the at least one processor electrically connected to the memory. The at least one processor executes the computer program to realize the method according to claim 1.

The above object, other objects, features, and advantages of the present disclosure will be made clear by the following detailed explanation of preferred embodiments with reference to the attached drawings.

### BRIEF DESCRIPTION OF THE DRAWINGS

FIG. 1 is a schematic diagram showing a schematic configuration of an entire estimating system that realizes a method of estimating a traveling situation of a vehicle according to one embodiment.

FIG. 2 is a block diagram showing a hardware configuration of the system shown in FIG. 1.

FIG. 3 is a block diagram showing the configuration of an estimating ECU shown in FIG. 2.

FIG. 4 is a flowchart showing the flow of an estimating process of estimating the situation of a field where the vehicle travels.

FIG. 5 is a histogram regarding a left-right acceleration of the vehicle.

FIG. 6 is a flowchart showing the flow of generating a classifier.

FIG. 7 is a conceptual diagram for explaining the flow of generating the classifier.

FIG. 8 is a map screen image displayed such that traveling situation categories associated with traveling sections are identifiable.

The above object, other objects, features, and advantages of the present disclosure will be made clear by the following detailed explanation of preferred embodiments with reference to the attached drawings.

### DESCRIPTION OF THE PREFERRED EMBODIMENTS

Hereinafter, an embodiment will be described with reference to the drawings.

### System Overview

In vehicle development, it is important to know user needs regarding vehicles. However, for example, even in the case of obtaining the needs directly from the users by questionnaires, it is difficult to grasp potential needs of the users. Moreover, it may be difficult for users who own vehicles to know appropriate maintenance of the vehicles, such as parts to be replaced or appropriate maintenance timings. The present embodiment can estimate how the vehicles are being used, in other words, estimate the situations of the vehicles. The present embodiment automatically collects information regarding how the vehicles are being used. The collected information may be information that is extremely useful for vehicle developers, vehicle users, vehicle maintenance companies, and the like. For example, the vehicle developers can grasp the potential needs of the users by using the information regarding how the vehicles are being used. Moreover, for example, the vehicle users, the vehicle maintenance companies, and the like can perform appropriate maintenance for the vehicles by using the information regarding how the vehicles are being used.

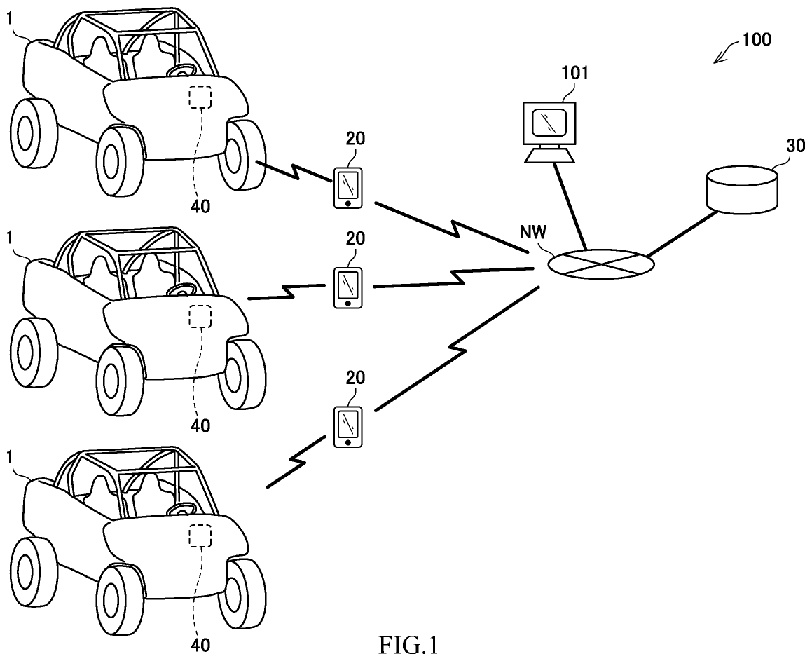

FIG. 1 is a schematic diagram showing a schematic configuration of an estimating system 100 that realizes a method of estimating a traveling situation of a vehicle 1 according to one embodiment of the present disclosure. For example, the vehicle 1 is an all terrain vehicle used to travel on unleveled road surfaces, so-called unleveled ground. As one example of this type of all terrain vehicle, a utility vehicle is described in the present embodiment. The all terrain vehicle travels on uneven road surfaces more frequently than a vehicle which travels on leveled ground. In this case, impact and the like received by the vehicle 1 from the road surface significantly change depending on influences of the traveling road surface where the vehicle 1 travels and influences of a traveling operation of a driver. Therefore, the lives of the parts of the same vehicles 1 significantly differ depending on use situations. Moreover, in the present embodiment, it is assumed that how to use the vehicle 1 differs among the users. As one example, the same type of vehicles 1 may be utilized for transportation of burdens in farm work, hunting, sport traveling, and some of these purposes.

In the present embodiment, the vehicle 1 includes an estimating ECU (Electronic Control Unit) 40. The estimating ECU 40 is one example of an estimator. The estimating ECU 40 estimates a traveling situation of the vehicle 1. Specifically, the estimating ECU 40 estimates the situation of a field where the vehicle 1 travels. In the present embodiment, based on a sensor value detected by at least one sensor mounted on the vehicle 1, the estimating ECU 40 estimates the traveling situation of the vehicle 1 at the time of the detection.

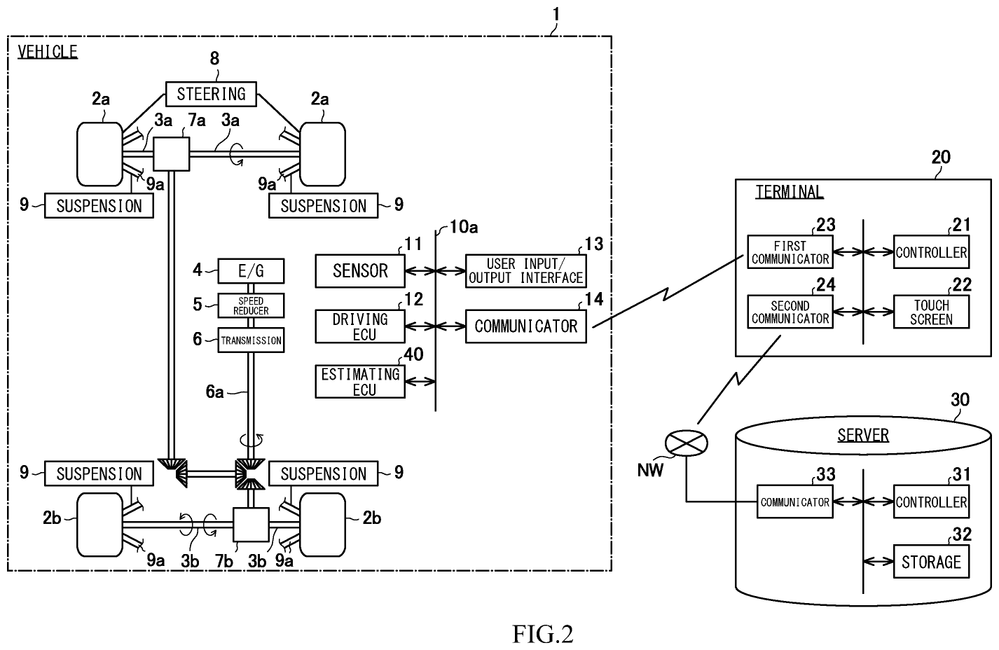

The estimating ECU 40 can perform transmission and reception of data with a predetermined terminal 20, located outside the vehicle 1, through a communicator 14 (see FIG. 2) mounted on the vehicle 1. For example, the terminal 20 is an information terminal carried by an occupant of the vehicle 1. The information terminal is, for example, a smartphone (multifunctional mobile phone). The terminal 20 can perform transmission and reception of data with a predetermined server 30 connected through the Internet or the like. Data including the result of the estimation performed by the estimating ECU 40 is transmitted through the communicator 14 and the terminal 20 to the server 30 located outside the vehicle 1 and is stored in the server 30.

The pieces of data transmitted to the server 30 are classified into predetermined classifications and stored in the server 30. For example, the data may be stored in the server 30 for each estimating ECU 40 or for each user of the vehicle 1. Moreover, the data may be stored in the server 30 for each type of the vehicle 1, for each regional group to which the vehicle 1 belongs, or for each user group classified based on a predetermined condition. The data stored in the server 30 may be utilized as information for supporting the user of the vehicle 1, for example, information regarding the maintenance of respective parts of the vehicle 1. Moreover, the data stored in the server 30 may be utilized as information for development feedback to a developer who developed the vehicle 1.

### Hardware Configuration

Next, a hardware configuration of the system shown in FIG. 1 will be described with reference to FIG. 2. Specifically, hardware configurations of the vehicle 1, the terminal 20, and the server 30 will be described with reference to FIG. 2.

### Vehicle

As described above, in the present embodiment, the vehicle 1 is a utility vehicle and includes a vehicle body frame (not shown in FIG. 2). A pair of left and right front wheels 2a are supported at a front portion of the vehicle body frame, and a pair of left and right rear wheels 2b are supported at a rear portion of the vehicle body frame. Front wheel brakes (not shown) are located at the front wheels 2a, and rear wheel brakes (not shown) are located at the rear wheels 2b. A pair of front drive shafts 3a extending in a left-right direction are respectively coupled to the front wheels 2a. A pair of rear drive shafts 3b extending in the left-right direction are respectively coupled to the rear wheels 2b.

Moreover, the vehicle 1 includes an engine unit that is a driving power source. The engine unit integrally includes an engine 4, a speed reducer 5, and a transmission 6 and is supported by the vehicle body frame. The engine 4 is an internal combustion engine. The engine 4 is, for example, a gasoline engine. The transmission 6 is, for example, a belt continuously variable transmission. Rotational power of the engine is changed in speed through the speed reducer 5 and the transmission 6 and is transmitted to an output shaft 6a. The rotational power transmitted to the output shaft 6a is transmitted to the front drive shafts 3a through a front wheel differential gear 7a and also transmitted to the rear drive shafts 3b through a rear wheel differential gear 7b.

The front wheel differential gear 7a is a mechanism that allows a rotation difference between the front wheels 2a, and the rear wheel differential gear 7b is a mechanism that allow a rotation difference between the rear wheels 2b. Each of the front wheel differential gear 7a and the rear wheel differential gear 7b has a differential lock (diff-lock) function that prevents, for example, the rotational frequency difference from being allowed. Moreover, the vehicle 1 has a power transmission switching function that can change the number of driving wheels rotated by the driving power source. Specifically, the vehicle 1 can switch between a four-wheel drive state in which the front and rear wheels 2a and 2b drive and a two-wheel drive state in which only the rear wheels 2b drive.

Moreover, the vehicle 1 includes a steering 8 that changes a traveling direction. The steering 8 includes: a steering wheel located at a driver's seat; and a steering structure that changes the direction of the front wheels 2a in accordance with the rotation of the steering wheel.

Moreover, the vehicle 1 includes suspensions 9 respectively located at four wheels 2a and 2b. The suspensions 9 are buffers that prevent the unevenness of the road surface from being transmitted to the vehicle body. Each of the suspensions 9 includes a swinging arm 9a, a spring (not shown), and a shock absorber (not shown). The swinging arm 9a supports the wheel 2a or 2b such that the wheel 2a or 2b can swing relative to the vehicle body frame. The spring (not shown) absorbs the impact transmitted from the wheel 2a or 2b. The shock absorber (not shown) is coupled to the swinging arm 9a and attenuates the vibration of the spring. For example, the swinging arm 9a is an upper arm of a double wishbone suspension, i.e., a so-called A arm.

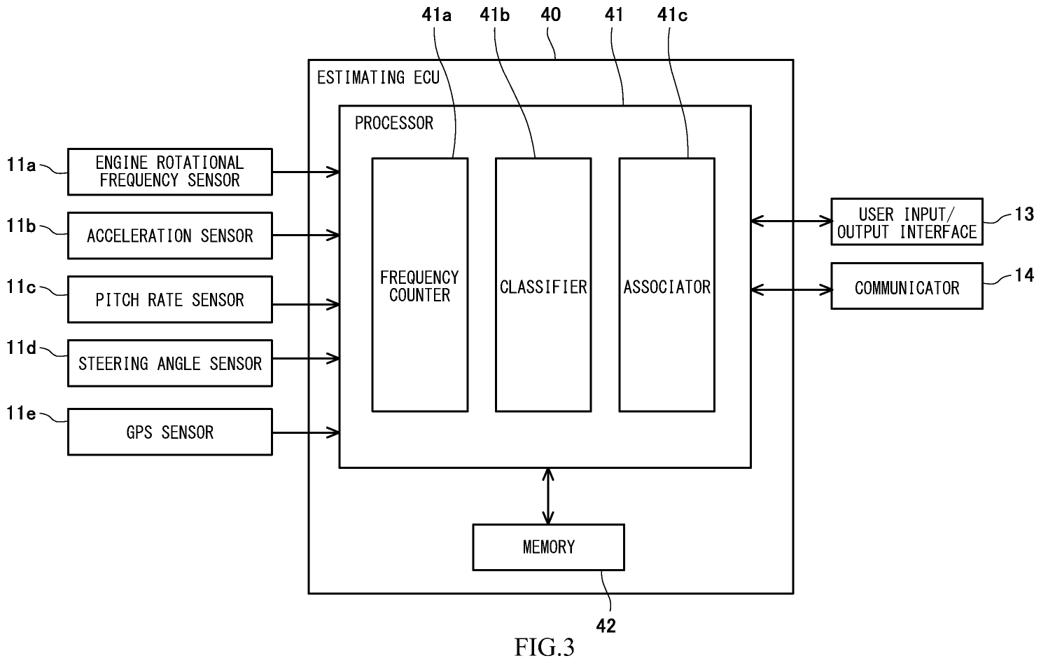

The vehicle 1 includes sensors 11 and driving ECUs 12. In FIG. 2, to simplify the drawing, the sensors 11 are shown by a single block, and the driving ECUs 12 are also shown by a single block. For example, as described below, the sensors 11 include an engine rotational frequency sensor 11a, an acceleration sensor 11b, a pitch rate sensor 11c, a steering angle sensor 11d, and a position sensor 11e (see FIG. 3).

Each of the driving ECUs 12 includes a processor, a volatile memory, a non-volatile memory, an I/O interface, and the like as hardware. The driving ECUs 12 are in connection with some or all of the sensors 11 and receive detected values detected by the sensors 11. The driving ECUs 12 control various control targets mounted on the vehicle 1 based on the detected values detected by the sensors 11.

The driving ECUs 12 may include, for example, an engine ECU, a suspension ECU, a brake ECU, and the like. The engine ECU electronically controls the engine 4. For example, the engine ECU is a FI (Fuel Injection)-ECU that electronically controls a fuel injector located at the engine 4 mounted on the vehicle 1. The suspension ECU electronically controls the suspensions 9. The brake ECU controls braking force generated by the front wheel brakes and the rear wheel brakes.

The vehicle 1 includes a user input/output interface 13 and the communicator 14. The sensors 11, the driving ECUs 12, the user input/output interface 13, the communicator 14, and the estimating ECU 40 are in connection with each other through a CAN bus 10a such that data transmission can be performed thereamong.

The user input/output interface 13 is a device that receives an input of the user and displays information. For example, the user input/output interface 13 includes a display. For example, the user input/output interface 13 presents the detected values of one or more sensors 11 or values calculated or acquired based on the detected values, to the driver of the vehicle 1. The user input/output interface 13 is, for example, a HMI (Human Machine Interface) meter. The user input/output interface 13 may be a touch screen. As a user input interface that receives the input of the user, the user input/output interface 13 may include a manipulation element, such as a button or a lever, which is configured separately from the display and receives the input of the user.

The communicator 14 performs wireless communication with a first communicator 23 of the terminal 20. For example, the communicator 14 may be configured integrally with or separately from the user input/output interface 13. Each of the communicator 14 and the first communicator 23 includes an antenna, a RF (Radio Frequency) circuit, and the like. In the present embodiment, the wireless communication performed by the communicator 14 and the first communicator 23 is Bluetooth (trademark) communication and is realized by pairing. The pairing denotes the execution of mutual authentication by which devices (in the present embodiment, the communicator 14 and the first communicator 23) can communicate with each other and are prevented from communicating with unrelated nearby devices. The communicator 14 and the first communicator 23 may perform wired communication.

A detailed configuration of the estimating ECU 40 will be described later.

### Terminal

The terminal 20 includes a controller 21, a touch screen 22, the first communicator 23, and a second communicator 24 as hardware. These structures 21 to 24 are in connection with each other such that data transmission can be performed thereamong.

The controller 21 controls the operation of the terminal 20. The controller 21 includes, for example, a calculation processing unit (CPU: Central Processing Unit), a ROM (Read Only Memory), a RAM (Random Access Memory), and the like.

The touch screen 22 serves as both an inputter that receives a manipulation input from the user and a display that displays a screen image visually confirmable by the user. Specifically, as the display, the touch screen 22 includes a semi-transmissive display and a back light LED. Moreover, as the inputter, the touch screen 22 includes a touch panel located on the display. The inputter and the display in the terminal 20 do not have to be integrated with each other and may be separated from each other.

The first communicator 23 performs wireless communication with a communicator 33 located at the vehicle 1. Since the first communicator 23 is the same in configuration as the communicator 14, an explanation thereof is omitted.

The second communicator 24 performs data communication with the communicator 33 of the server 30 through a network NW, such as the Internet, by wireless communication.

### Server

The server 30 includes a controller 31, a storage 32, and the communicator 33 as hardware. These structures 31 to 33 are in connection with each other such that data transmission can be performed thereamong.

The controller 31 (also called server controller) controls the operation of the server 30. The controller 31 includes a calculation processing unit, such as a CPU. The storage 32 includes, for example, non-volatile memories such as a hard disk and a ROM, and a volatile memory such as a RAM. For example, the storage 32 stores data transmitted from the estimating ECU 40 through the terminal 20. The communicator 33 (also called a server communicator) communicates with the first communicator 23 of each terminal 20 through the network NW.

### Configuration of Estimating ECU

Next, a specific configuration of the estimating ECU 40 will be described with reference to FIG. 3.

The sensors 11 include the engine rotational frequency sensor 11a, the acceleration sensor 11b, the pitch rate sensor 11c, the steering angle sensor 11d, and the position sensor 11e. The estimating ECU 40 receives sensor values detected by these sensors 11a, 11b, 11c, 11d, and 11e. The engine rotational frequency sensor 11a detects the rotational frequency of the engine 4. The acceleration sensor 11b detects the acceleration of the vehicle 1 in the left-right direction. The pitch rate sensor 11c detects pitch behavior, generated by pitching during traveling of the vehicle 1, as a pitching rate. The steering angle sensor 11d detects the rotation angle of the steering 8. The position sensor 11e detects a geographical position of the vehicle 1. For example, the position sensor 11e is a GPS (Global Positioning System) sensor.

The estimating ECU 40 includes at least one processor 41 and at least one memory 42 as hardware. The memory 42 includes, for example, a hard disk, a flash memory, or a non-volatile memory such as a ROM. The estimating ECU 40 may be realized by the same hardware as the driving ECU 12 or may be realized by different hardware from the driving ECU 12.

FIG. 3 also shows a functional configuration of the at least one processor 41 of the estimating ECU 40. The at least one processor 41 includes a frequency counter 41a, a classifier 41b, and an associator 41c as functions. For example, a non-transitory storage medium (non-transitory computer readable medium) included in the at least one memory 42 stores various programs. These functional parts 41a, 41b, and 41c are realized in such a manner that the at least one processor 41 executes various programs (such as a below-described frequency counting program, a below-described classifying program, and a below-described associating program).

The estimating ECU 40 acquires sensor values from various sensors 11 while the vehicle 1 is traveling. Based on the acquired sensor values, the estimating ECU 40 estimates the type of the field where the vehicle 1 is traveling. In the present embodiment, the estimating ECU 40 estimates which of predetermined three traveling field categories the field where the vehicle 1 is traveling corresponds to, specifically, which of a dune, an open desert, and a rock section the field where the vehicle 1 is traveling corresponds to. The “dune” denotes a sand dune. The “open desert” denotes a vast waste land or desert including rocks and gravel (sand and small stones). The “rock section” is a field where, for example, stones and rocks of several tens of centimeters are located. The three traveling fields are different in the unevenness and hardness of the road surface from each other.

### Operation Process of Estimating ECU

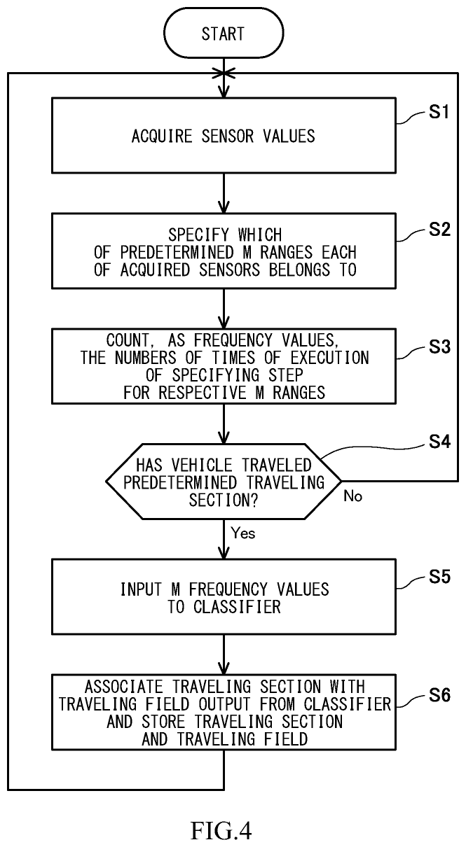

The flow of an estimating process of estimating the traveling situation of the vehicle 1 by the estimating ECU 40, i.e., the situation of the field where the vehicle 1 travels will be described with reference to FIG. 4. The estimating process is executed while the vehicle 1 is traveling.

In the estimating process, the at least one processor 41 receives the sensor values detected by various sensors 11 (Step S1).

The at least one processor 41 specifies which of predetermined M ranges each of the received sensor values belongs to (Step S2). M is an integer of two or more. Regarding the M ranges, the “ranges” may also be referred to as “ranks”. Then, the at least one processor 41 counts, as frequency values, the numbers of times of the execution of the above specifying step for the respective ranges, i.e., for the respective ranks (Step S3). M that is the number of M ranges is a predetermined value as an input value input to the classifier 41b.

The sensor values counted as the frequency value in Step S3 indicate information regarding the behavior of the vehicle 1. In the present embodiment, the values detected by the engine rotational frequency sensor 11a, the acceleration sensor 11b, the pitch rate sensor 11c, and the steering angle sensor 11d are counted as the frequency value. To be specific, among the received sensor values, the rotational frequency of the engine 4, the acceleration of the vehicle 1 in the left-right direction, the pitch rate of the vehicle 1, and the steering angle of the vehicle 1 are counted as the frequency value. The sensors, such as the engine rotational frequency sensor 11a, the acceleration sensor 11b, the pitch rate sensor 11c, and the steering angle sensor 11d, which detect the information regarding the behavior of the vehicle 1 may also be called behavior sensors.

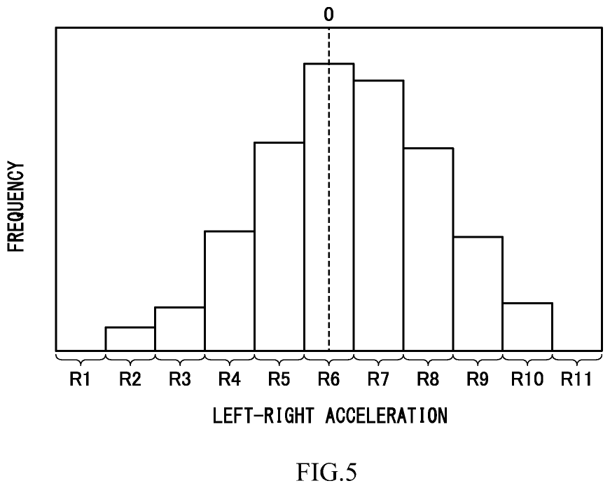

Counting the frequency value will be specifically described with reference to FIG. 5. FIG. 5 is a histogram regarding a left-right acceleration. In FIG. 5, a horizontal axis represents the ranks of the left-right acceleration, and a vertical axis represents the frequency. In FIG. 5, eleven ranks R1 to R11 are shown as the ranks of the left-right acceleration. The at least one processor 41 specifies which of the eleven ranges each of the sensor values received from the behavior sensors belongs to. Then, the at least one processor 41 counts, as the frequency values, the numbers of times of the execution of the above specifying step for the respective ranks. The widths of the eleven ranks R1 to R11, i.e., rank widths may be the same as each other or different from each other. The number of ranks is a value corresponding to the classifier 41b.

In the present embodiment, in addition to the left-right acceleration, the frequency values of the engine rotational frequency, the pitch rate, and the steering angle are counted and used as the input values input to the classifier 41b. To be specific, the value “M” in Step S2 is a total of the number of ranks set for the left-right acceleration, the number of ranks set for the engine rotational frequency, the number of ranks set for the pitch rate, and the number of ranks set for the steering angle.

Referring back to FIG. 4, the at least one processor 41 determines whether or not the vehicle has traveled a predetermined traveling section (Step S4). The situation of the field is estimated for each predetermined traveling section. Hereinafter, the predetermined traveling section may also be called an estimation target section.

When the at least one processor 41 determines in Step S4 that the vehicle 1 has not traveled the estimation target section (No in Step S4), the at least one processor 41 returns to Step S1. That is, while the vehicle 1 is traveling the estimation target section, the at least one processor 41 receives the sensor values, detected by the sensors 11 mounted on the vehicle 1, plural times. To be specific, while the vehicle 1 is traveling the estimation target section, counting the frequency values of the M ranges is continuously executed. As above, the at least one processor 41 reads and executes the frequency counting program, stored in the memory 42, to function as the frequency counter 41a.

The estimation target section may be, for example, a section where the vehicle 1 has traveled for a set period of time. In this case, the at least one processor 41 determines in Step S4 whether or not the set period of time has elapsed. The set period of time may be set in accordance with the vehicle speed of the vehicle 1. That is, the at least one processor 41 may receive the vehicle speed from the vehicle speed sensor included in the sensors 11 and mounted on the vehicle 1, and determine the set period of time based on the vehicle speed. To be specific, the at least one processor 41 may determine the estimation target section based on the vehicle speed.

For example, the set period of time may be set so as to decrease as the detected vehicle speed increases. For example, a distance that the vehicle 1 travels at low speed for ten seconds and a distance that the vehicle 1 travels at high speed for ten seconds are extremely different from each other. When the set period of time stays the same regardless of the vehicle speed, the section for estimating the situation of the traveling field may become extremely short or long. The at least one processor 41 sets the set period of time such that as the vehicle speed increases, the set period of time decreases. Moreover, the at least one processor 41 also sets the section where the vehicle 1 has traveled for the set period of time as the estimation target section. With this, the section for estimating the traveling field is prevented from becoming extremely short or long.

Moreover, the estimation target section may be, for example, a section corresponding to a predetermined travel distance of the vehicle 1. In this case, the at least one processor 41 determines in Step S4 whether or not the vehicle 1 has traveled the predetermined travel distance. For example, the travel distance may be calculated from the detected value of the vehicle speed sensor or from the detected value of the GPS sensor.

Moreover, the estimation target section may be changeable in accordance with the manipulation of the user to the user input/output interface 13. To be specific, the user may be able to appropriately adjust the distance of the traveling section for estimating the situation of the field. Since the user can change the section for estimating the traveling field in accordance with the situation, the section for estimating the traveling field can be prevented from becoming extremely short or long.

When the at least one processor 41 determines in Step S4 that the vehicle 1 has traveled the estimation target section (Yes in Step S4), the M frequency values respectively corresponding to the M ranges are input to the classifier 41b (Step S5). The classifier 41b receives the M frequency values as input data and generates output data corresponding to the input data. As the output data, the classifier 41b outputs traveling situation category information indicating any of three types of predetermined traveling situation categories each showing the traveling situation of the vehicle 1. The output data is a situation estimation result indicating the traveling situation of the vehicle 1 in the estimation target section. As described above, the three types of traveling situation categories are the dune, the open desert, and the rock section.

The at least one processor 41 reads and executes the classifying program, stored in the memory 42, to function as the classifier 41b. The classifying program may be a learned model generated by machine learning or the like. A method of generating the classifier 41b and the details of the classifier 41b will be described later.

The at least one processor 41 associates the traveling section of the vehicle 1 with the traveling field output from the classifier 41b, and stores and outputs the traveling section and the traveling field (Step S6). To be specific, the least one processor 41 associates the traveling situation category information output from the classifier 41b with traveling section information indicating the estimation target section of the vehicle 1 and stores the traveling situation category information and the traveling section information in the memory 42. As above, the at least one processor 41 reads and executes the associating program, stored in the memory 42, to function as the associator 41c.

Specifically, by the positional information detected by the position sensor 11e, the at least one processor 41 acquires the traveling section information indicating the estimation target section of the vehicle 1. The at least one processor 41 associates the acquired traveling section information with the traveling field output from the classifier 41b and stores the traveling section information and the traveling field in the memory 42.

The traveling section information may be, for example, some or all of the values detected by the position sensor 11e while the vehicle 1 is traveling the estimation target section, i.e., in a period from when counting the M frequency values is started until when it is determined in Step S4 that the vehicle has traveled the estimation target section, or may be information generated based on some or all of the values detected by the position sensor 11e while the vehicle 1 is traveling the estimation target section.

For example, the at least one processor 41 may acquire the traveling section information based on traveling route information, prestored in the memory 42, in addition to the positional information detected by the position sensor 11e. In this case, for example, the at least one processor 41 may specify the estimation target section of the traveling route based on the positional information when counting the M frequency values is started, the positional information when it is determined in Step S4 that the vehicle 1 has traveled the estimation target section, and the traveling route information. For example, the traveling route information may be information which is prestored in the memory 42 and relates to a route along which the vehicle plans to travel or may be road information indicating the positions of roads on a map.

Moreover, the at least one processor 41 transmits the traveling section information and the traveling situation category information, stored in the memory 42, to the terminal 20 through the communicator 14. In the terminal 20, the controller 21 transmits the received traveling section information and the received traveling situation category information to the server 30. The storage 32 of the server 30 stores the traveling section information and the traveling situation category information which are associated with each other.

A timing at which the information is transmitted from the estimating ECU 40 to the server 30 is not especially limited. For example, transmitting the traveling section information and the traveling situation category information from the vehicle 1 to the terminal 20 may be performed at a predetermined cycle. A timing at which the traveling section information and the traveling situation category information are transmitted from the terminal 20 to the server 30 does not have to be a timing immediately after the terminal 20 has received the traveling section information and the traveling situation category information from the vehicle 1. For example, the traveling section information and the traveling situation category information may be transmitted from the terminal 20 to the server 30 when predetermined manipulation of the user with respect to the terminal 20 is performed after the traveling section information and the traveling situation category information in the terminal 20.

After Step S6, the at least one processor 41 resets the frequency values of the M ranges (Step S7) and returns to Step S1. To be specific, the at least one processor 41 proceeds to the estimation of the situation of the traveling field with respect to the next estimation target section.

### Method of Generating Classifier

As described above, the classifier 41b receives the M frequency values as the input data and outputs the traveling situation category information as the output data corresponding to the input data. The traveling situation category information is information indicating any of three types of traveling situations that are the dune, the open desert, and the rock section. In the present embodiment, the classifier 41b specifies a representative vector closest to a vector constituted by the M frequency values from among three representative vectors respectively associated with the three types of traveling situations, and outputs the traveling situation category corresponding to the specified representative vector.

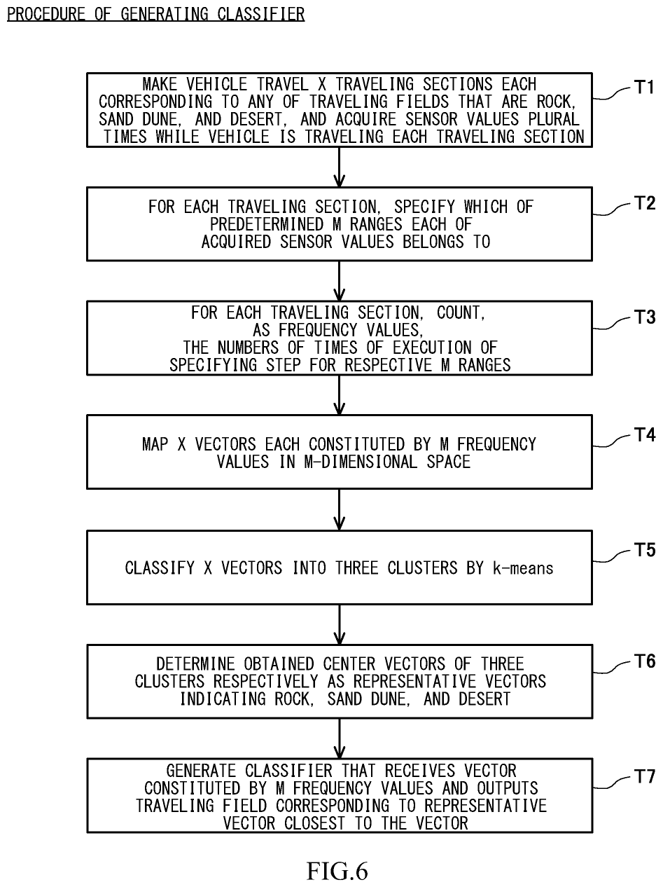

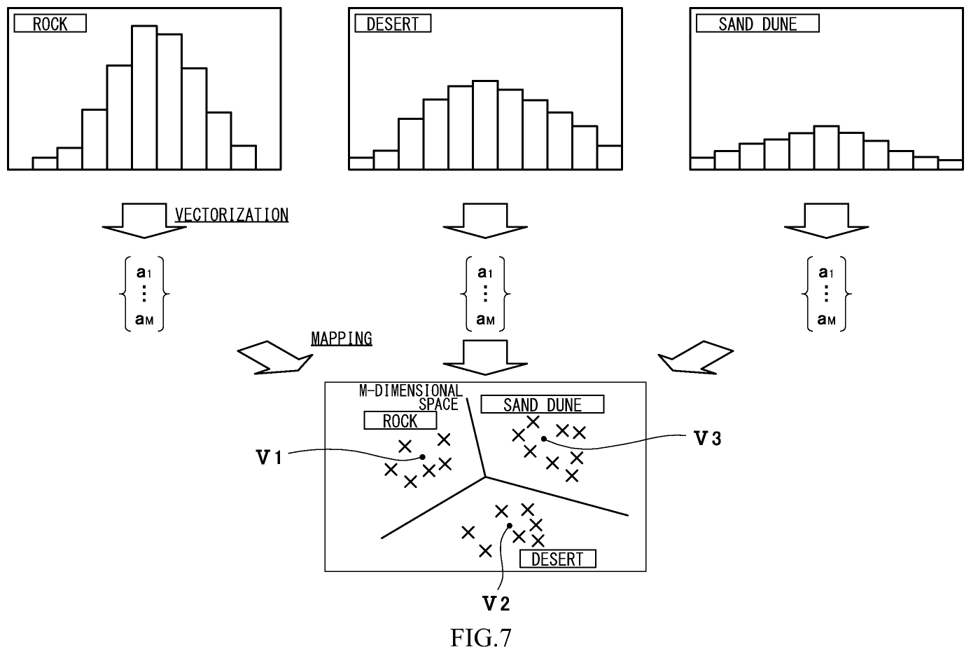

The method of generating the classifier 41b will be described with reference to FIGS. 6 and 7. FIG. 6 is a flowchart showing the flow of generating the classifier 41b. FIG. 7 is a conceptual diagram for explaining the flow of generating the classifier 41b.

### Preparation of Data

To generate the classifier 41b, first, a learning data set is prepared.

Specifically, to acquire data, a vehicle for data acquisition (hereinafter referred to as a data collection vehicle) that is the same in configuration as the vehicle 1 is prepared, and the data collection vehicle is made to travel X traveling sections each of which corresponds to any of the traveling fields that are the dune, the open desert, and the rock section. The data collection vehicle includes the behavior sensors, i.e., the engine rotational frequency sensor 11a, the acceleration sensor 11b, the pitch rate sensor 11c, and the steering angle sensor 11d. While the data collection vehicle is traveling each traveling section, the sensor values obtained by the behavior sensors are acquired plural times (Step T1).

By using the frequency counter, which of the predetermined M ranges each of the acquired sensor values belongs to is specified for each traveling section (Step T2), and the numbers of times of the execution of the above specifying step for the respective ranges are counted as the frequency values (Step T3). The frequency counter may be an ECU mounted on the data collection vehicle or may be an external device, such as a personal computer, located outside the data collection vehicle. To be specific, the frequency counter may read and execute the frequency counting program stored in the memory.

Thus, the data of the M frequency values is obtained for one traveling section. X vectors each constituted by the M frequency values {a1, a2, . . . , aM} are obtained by the traveling of the X traveling sections. The X pieces of vector data become the learning data set. Each vector corresponds to any of the traveling fields that are the dune, the open desert, and the rock section. In FIG. 7, to simplify the drawing, histograms corresponding to the three types of traveling fields that are the dune, the open desert, and the rock section and vectors corresponding to the three types of traveling fields that are the dune, the open desert, and the rock section are shown.

### Generation of Classifier Using Machine Learning

Next, X vectors {a1, a2, . . . , aM} of the learning data set are mapped in an M-dimensional space (Step T4). Then, the X vectors are classified by k-means into three clusters corresponding to the number of types of the traveling fields (Step T5).

In the k-means, the X vectors are suitably classified into three clusters, and the center of each cluster is obtained. After that, distances between the obtained three centers and the X vectors are obtained, and each vector is classified again into the cluster corresponding to the center closest to the vector. The above process is repeated until the position of the center do not substantially change any more.

Thus, the center vectors of the three clusters are obtained. The obtained three center vectors are determined respectively as representative vectors V1, V2, and V3 indicating the dune, the open desert, and the rock section (Step T6). For example, a human may determine which of the traveling situations that are the dune, the open desert, and the rock section each representative vector V1, V2, or V3 is associated with, i.e., each center vector is associated with. For example, among three center vectors, the center vector to which most of the vectors obtained when the vehicle has traveled the dune are close may be determined as the center vector corresponding to the dune.

Thus, the classifier is generated by using the three representative vectors V1, V2, and V3 corresponding to the dune, the open desert, and the rock section. To be specific, generated is the classifier that: receives the M frequency values; specifies which of the three representative vectors V1, V2, and V3 the vector constituted by the input M frequency values is related to; and outputs the traveling situation category associated with the specified representative vector (Step T7). Specifically, generated is the classifying program that: receives the M frequency values; specifies a representative vector closest to the vector constituted by the input M frequency values from among the three representative vectors V1, V2, and V3; and outputs the traveling situation category associated with the specified representative vector.

Thus, the obtained classifying program is stored in the memory 42 of the estimating ECU 40 of the vehicle 1 used by the user.

### Update of Classifier

In the present embodiment, the classifying program stored in the memory 42 of the estimating ECU 40 may be updated. For example, when a highly accurate classifying program is newly generated, such classifying program may be stored in the storage 32 of the server 30. This classifying program may be transmitted from the server 30 through the terminal 20 to the estimating ECU 40 of the vehicle 1, and with this, the classifying program stored in the memory 42 may be updated by the newly generated classifying program in the estimating ECU 40 of the vehicle 1.

Moreover, in the present embodiment, learning data for newly generating the highly accurate classifying program may be collected from the vehicle 1 used by the user. For example, in addition to the traveling section information and the traveling situation category information stored in the memory 42, the at least one processor 41 may transmit a set (hereinafter referred to as frequency information) of the M frequency values corresponding to the traveling section information, through the terminal 20 to the server 30. Thus, the traveling section information and the frequency information transmitted from the vehicle 1 of each user are associated with each other and stored in the storage 32 of the server 30. Plural data sets of the traveling section information and the frequency information stored in the server 30 as above may be used as the learning data set for generating the new classifier. The learning data sets collected from the user as above may be utilized for generating the classifier by machine learning other than the k-means.

### Utilization of Information Stored in Server

The traveling section information and the traveling situation category information stored in the storage 32 of the server 30 can be variously utilized.

For example, the vehicle developer, the maintenance company, or the like can access, from a terminal 101 (see FIG. 1), the traveling section information and the traveling situation category information stored in the storage 32 of the server 30. The terminal 101 is the same in configuration as the terminal 20. To be specific, the terminal 101 includes a CPU, a memory, a communicator, and the like. As with the terminal 20, the terminal 101 may include, as an inputter and a display, the touch screen 22 configured by integrating an inputter and a display with each other. Moreover, the terminal 101 may include an inputter, such as a mouse and a keyboard, and may include a display in addition to the inputter. The terminal 101 may be a known terminal, such as a personal computer or a tablet terminal.

For example, the traveling situation category information may be associated with the user identification information or the vehicle identification information and stored in the storage 32. In this case, the maintenance company can access from the terminal 101 the information stored in the server 30, and with this, can grasp which type of traveling field each vehicle 1 tends to travel. For example, in the case of the vehicle 1 which tends to travel a field, such as the “rock section”, having a ground surface from which the vehicle 1 tends to receive impact, for example, the cycle of the replacement of parts is shortened, or the maintenance timing is made earlier, i.e., appropriate maintenance service can be provided for each user.

Moreover, the traveling section information and the traveling situation category information can be utilized for the diagnosis of the malfunction of the vehicle 1. For example, when an abnormality occurs in the vehicle 1, the traveling situation where the vehicle 1 has traveled immediately before the occurrence of the abnormality may be utilized to find the cause of the malfunction.

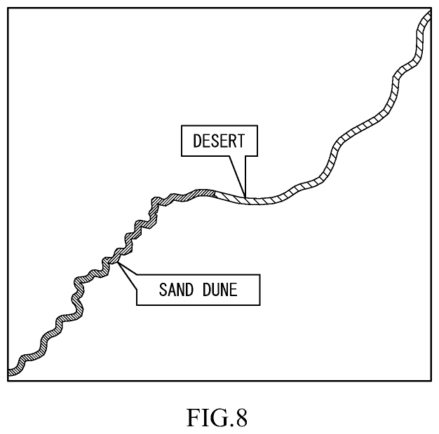

For example, the user of the vehicle 1 can also access the traveling section information and the traveling situation category information stored in the storage 32 of the server 30. FIG. 8 is a map screen image displayed such that the traveling situation categories associated with the traveling sections are identifiable. When the CPU 21 of the terminal 20 receives the traveling section information and the traveling situation category information from the server 30, the CPU 21 may display a traveling course including the traveling section on the touch screen 22 in such a manner that the traveling situation category associated with the traveling section is identifiable. As above, since the map screen image shows a correspondence relation between the traveling section and the traveling situation, the correspondence relation between the traveling section and the traveling situation is easily grasped. The user can grasp in advance the field situation of a course along which the vehicle of the user plans to travel.

Moreover, the ECU 40 of the vehicle 1 may receive the traveling section information and the traveling situation category information from the server 30 through the terminal 20. The ECU 40 of the vehicle 1 may display the traveling course including the traveling section on the user input/output interface 13 based on the received traveling section information and the received traveling situation category information in such a manner that the traveling situation category associated with the traveling section is identifiable.

### Operational Advantages

As described above, according to the present embodiment, the at least one processor 41 specifies which of the predetermined M ranges each of the received sensor values belongs to, and counts, as the frequency values, the numbers of times of the execution of the above specifying step for the respective ranges. Thus, the number of input values input to the classifier 41b can be set to M, i.e., an appropriate value. With this, both reducing the calculation cost of the at least one processor 41 and maintaining the accuracy of the estimation of the traveling situation by the at least one processor 41 can be realized.

Moreover, in the present embodiment, the traveling situation, i.e., the situation of the field where the vehicle 1 travels is estimated for each estimation target section. Therefore, the accuracy of the estimation of the situation of the traveling field can be improved.

### OTHER EMBODIMENTS

The present disclosure is not limited to the above embodiment, and various modifications may be made within the scope of the present disclosure.

In the above embodiment, the utility vehicle is described as one example of the vehicle. However, the present disclosure is also applicable to vehicles, such as motorcycles, automatic three-wheeled vehicles, and riding lawn mowers, in addition to the utility vehicles. The driving source of the vehicle is not especially limited. The vehicle may be an engine vehicle or an electric vehicle. The present disclosure is especially suitable for off-road traveling vehicles which are assumed to be used in various use situations.

In the above embodiment, the engine rotational frequency sensor 11a, the acceleration sensor 11b, the pitch rate sensor 11c, and the steering angle sensor 11d are described as the behavior sensors. However, the behavior sensors are not limited to these. The behavior sensors may include an IMU (Inertial Measurement Unit). The IMU is a device that detects angular velocities and accelerations of three axes extending in the front-rear direction, the left-right direction, and the upper-lower direction of the vehicle 1. The acceleration sensor 11b may be the IMU. In Step S2, which of the M ranges each of the sensor values acquired from the behavior sensors belongs to may be specified, or which of the M ranges each of the sensor values acquired from one behavior sensor belongs to may be specified.

The behavior sensors may be two or more out of the engine rotational frequency sensor 11a, the acceleration sensor 11b, the pitch rate sensor 11c, and the steering angle sensor 11d. The behavior sensors may include a sensor other than the engine rotational frequency sensor 11a, the acceleration sensor 11b, the pitch rate sensor 11c, and the steering angle sensor 11d. Examples of the detected values detected by the behavior sensors include: the travel distance of the vehicle 1; the traveling speed and speed change of the vehicle 1; the rotational speed and speed change of the driving power source mounted on the vehicle 1; the throttle position: the gear position; the wheel speeds and speed changes of the front wheels and the rear wheels; the front-rear speeds and speed changes of the speed reducer, the continuously variable transmission, the hydraulic clutch, and the like; the steering angle and the angular change; the suspension stroke (Front Stroke and Rear Stroke) and the stroke change; the acceleration (front-rear acceleration) of the vehicle 1 in the front-rear direction; the acceleration (lateral acceleration) of the vehicle 1 in the left-right direction; the acceleration (upward-downward acceleration) of the vehicle 1 in the upper-lower direction; the posture changes of the vehicle body in the pitch direction, the roll direction, and the yaw direction; and the brake pressure and the pressure change. The behavior sensors may include, for example, various ECUs mounted on the vehicle 1. In this case, the detected values of various ECUs may be values obtained in such a manner that various ECUs process the detected values obtained from other sensors mounted on the vehicle 1.

In the above embodiment, as the output data, the classifier outputs the traveling situation category information indicating any of the traveling situation categories that are the dune, the open desert, and the rock section. However, the types of the traveling situation categories output from the classifier and the number of traveling situation categories are not limited to the above. For example, the types of the traveling situation categories may include a paved road, an acrobatic field, and the like. The “paved road” is a road surface that is leveled and has relatively small unevenness. The “acrobatic field” is a field for acrobatic traveling, and is, for example, a field where a jump stand by which the vehicle 1 jumps is located. Moreover, the traveling situation categories may include “mud”, “forest”, “mountain”, “watercourse crossing”, and the like.

Moreover, the traveling situation category does not have to indicate the type of the road surface state and may be a category indicating the type of the situation generated in the vehicle in accordance with the road surface on which the vehicle travels. For example, the traveling situation categories may include a suspension load field, a driving wheel load field, an impact field, an engine high temperature field, and the like. The suspension load field is a field where a suspension stroke amount or a stroke speed is relatively larger than that in the other fields. The driving wheel load field is a field where wheel spin, such as slip or stuck, occurs more easily than the other fields. The impact field is a field where the wheel receives a predetermined impact or more from the road surface when the vehicle 1 collides with an obstacle, jumps, or the like. The engine high temperature field is a field where the temperature of the engine 4 mounted on the vehicle 1 becomes relatively higher than the other fields.

In the above embodiment, generated is the classifying program that: receives the M frequency values; specifies a representative vector closest to the vector constituted by the input M frequency values from among the three representative vectors V1, V2, and V3; and outputs the traveling situation category associated with the specified representative vector. However, the classifying program is not limited to this. For example, the classifier does not have to specify the representative vector closest to the vector constituted by the input M frequency values from among the three representative vectors V1, V2, and V3, but may specify one representative vector from among the three representative vectors V1, V2, and V3 based on a different relational formula.

The classifier is generated by using the k-means. However, the method of generating the classifier is not limited to this. For example, the classifier may be a learned model obtained by performing supervised learning, such as a neural network. In this case, the learning data used to generate the classifier may include: plural pieces of frequency information, i.e., plural pieces of vector data in which each vector is constituted by the M frequency values; and plural pieces of traveling situation category information respectively corresponding to plural pieces of frequency information.

Moreover, the above embodiment describes a case where the method of estimating the traveling situation of the vehicle is executed by the processor mounted on the vehicle. However, the method of estimating the traveling situation of the vehicle does not have to be executed by the processor mounted on the vehicle. To be specific, the estimator may be a device located outside the vehicle. For example, the method of estimating the traveling situation of the vehicle may be executed by a processor of an external device, such as the terminal 20, the terminal 101, the server 30, or the like located outside the vehicle. For example, the traveling situation of the vehicle can be estimated in a cloud. When executing the method of estimating the traveling situation of the vehicle by the processor of the external device located outside the vehicle, the method is executed based on information transmitted from the vehicle and stored in the memory of the external device. To be specific, the sensor values of the behavior sensors mounted on the vehicle are transmitted from the vehicle to the external device together with the positional information of the vehicle at the time of the detection of the sensor values, and are accumulated in the memory of the external device. With this, the external device can suitably estimate the traveling situation where the vehicle has traveled, based on the information collected from the vehicle. The method of generating the classifier that estimates the traveling situation of the vehicle may be executed by the processor of the vehicle or by the processor of the external device located outside the vehicle.

The functionality of the elements disclosed herein may be implemented using circuitry or processing circuitry which includes general purpose processors, special purpose processors, integrated circuits, ASICs (“Application Specific Integrated Circuits”), conventional circuitry or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware or processor.

Moreover, various programs disclosed in the present specification are stored in a storage. The storage is a device which is incorporated in or externally attached to a computer and is readable and writable or readable. For example, the storage may be a hard disk, a flash memory, an optical disk, or the like. The program stored in the storage may be executed by a computer to which the storage is directly connected or may be downloaded to and executed by a computer connected to the storage through a network (for example, the Internet).

### DISCLOSED ASPECTS

The following aspects disclose preferred embodiments.

### First Aspect

A method of estimating a traveling situation of a vehicle, the method including:
by at least one processor, receiving sensor values, obtained by at least one sensor mounted on the vehicle, plural times while the vehicle is traveling a traveling section;
specifying which of predetermined M ranges each of the received sensor values belongs to, M being an integer of two or more;
counting, as frequency values, the numbers of times of the execution of the specifying step for the respective ranges;
inputting, to a classifier, the counted M frequency values respectively corresponding to the M ranges; and
outputting, from the classifier, any of K types of predetermined traveling situation categories respectively indicating traveling situations of the vehicle, as a situation estimation result indicating the traveling situation of the vehicle in the traveling section, K being an integer of two or more.

According to the above aspect, the at least one processor specifies which of the predetermined M ranges each of the received sensor values belongs to, and counts, as the frequency values, the numbers of times of the execution of the specifying step for the respective ranges. Thus, the number of input values input to the classifier can be set to an appropriate value by which the calculation cost can be reduced and the accuracy of the estimation can be maintained. Therefore, both reducing the calculation cost of the at least one processor and maintaining the accuracy of the estimation of the traveling situation by the at least one processor can be realized.

Moreover, since the situation estimation result indicating the traveling situation of the vehicle is output for each traveling section, the accuracy of the estimation of the traveling situation of the vehicle can be improved.

### Second Aspect

The method according to the first aspect, wherein:
the classifier specifies a representative vector closest to a vector constituted by the M frequency values from among K representative vectors respectively associated with the K types of traveling situation categories; and the classifier outputs the traveling situation category corresponding to the specified representative vector.

According to the above aspect, the traveling situation corresponding to the input vector can be estimated by a simple method of specifying the representative vector closest to the input vector.

### Third Aspect

The method according to the first or second aspect, including changing the traveling section in accordance with manipulation of a user of the vehicle.

According to the above aspect, the section for estimating the traveling situation can be changed by the user in accordance with the situation. Therefore, the section for estimating the traveling situation is prevented from becoming extremely short or long.

### Fourth Aspect

The method according to any one of the first to third aspects, wherein the sensor values include a rotational frequency of an engine mounted on the vehicle, acceleration of the vehicle in a left-right direction, a pitch rate of the vehicle, or a steering angle of the vehicle.

According to the above aspect, the tendency of the traveling situation is easily reflected on the frequency value, and the accuracy of the estimation of the traveling situation of the vehicle is easily improved.

### Fifth Aspect

The method according to any one of the first to fourth aspects, including:
associating the output traveling situation category with the traveling section and storing the traveling situation category and the traveling section; and
displaying a traveling course including the traveling section on a display such that the traveling situation category associated with the traveling section is identifiable.

According to the above aspect, the correspondence relation between the traveling section and the traveling situation is easily grasped.

### Sixth Aspect

A method of generating a classifier that estimates a traveling situation of a vehicle, the method including:
making a vehicle including at least one sensor travel X traveling sections, X being an integer of two or more;
receiving sensor values, obtained by the at least one sensor, plural times while the vehicle is traveling each traveling section;
specifying which of predetermined M ranges each of the received sensor values belongs to, M being an integer of two or more;
counting, as frequency values, the numbers of times of the execution of the specifying step for the respective ranges; and
generating, as at least a part of a learning data set, data indicating X vectors respectively corresponding to the X traveling sections, each vector being constituted by the M frequency values.

According to the above aspect, for example, by performing machine learning in which the M frequency values in the learning data set are used as the input values, the classifier in which the number of input values is M can be generated. The number of input values input to the classifier can be set to an appropriate value by which the calculation cost can be reduced and the accuracy of the estimation can be maintained. Therefore, both reducing the calculation cost of the at least one processor and maintaining the accuracy of the estimation of the traveling situation by the at least one processor can be realized.

### Seventh Aspect

The method according to the sixth aspect, including after the learning data set is generated, classifying the X vectors of the learning data set into K clusters by k-means and generating K representative vectors, K being an integer of two or more.

According to the above aspect, K that is the number of classifications of the traveling situation can be suitably set by using the k-means.

### Eighth Aspect

The method according to the seventh aspect, including after the K representative vectors are generated, respectively associating the K representative vectors with K types of traveling situation categories.

### Ninth Aspect

The method according to the eighth aspect, including generating a classifier that:
receives the M frequency values based on the at least one sensor mounted on the vehicle;
specifies which of the K representative vectors the vector constituted by the input M frequency values is related to; and
outputs the traveling situation category associated with the specified representative vector.

### Tenth Aspect

The method according to any one of the first to ninth aspects, wherein the vehicle is an all terrain vehicle.

### Eleventh Aspect

The method according to any one of the first to tenth aspects, wherein:
the traveling situation category denotes a type of an area where the vehicle travels; and
the K types of traveling situation categories include a desert area, a sand dune area, and a rock area.

### Twelfth Aspect

The method according to any one of the first to fifth aspects, including:
transmitting the output situation estimation result from the vehicle to a server; and storing the received situation estimation result in the server.

According to the above aspect, by storing the situation estimation result in the server, people other than vehicle users can easily utilize the situation estimation result.

### Thirteenth Aspect

An estimator that estimates a traveling situation of a vehicle,
the estimator including:
a memory storing a computer program; and
the at least one processor electrically connected to the memory, wherein the at least one processor executes the computer program to realize the method according to any one of the first to fifth aspects.

As described above, the embodiment has been described as an example of the technology disclosed in the present application. However, the technology in the present disclosure is not limited to this and is also applicable to embodiments in which modifications, replacements, additions, omissions, and the like are suitably made. Moreover, a new embodiment may be prepared by combining the components described in the above embodiment. For example, some of components or methods in one embodiment may be applied to another embodiment. Some components in an embodiment may be separated and arbitrarily extracted from the other components in the embodiment. Furthermore, the components shown in the attached drawings and the detailed explanations include not only components essential to solve the problems but also components for exemplifying the above technology and not essential to solve the problems.

What is claimed is:

1. A method of estimating a traveling situation of a vehicle,
the method comprising:
by at least one processor,
receiving sensor values, obtained by at least one sensor mounted on the vehicle, plural times while the vehicle is traveling a traveling section;
specifying which of predetermined M ranges each of the received sensor values belongs to, M being an integer of two or more;
counting, as frequency values, the numbers of times of the execution of the specifying step for the respective ranges;
inputting, to a classifier, the counted M frequency values respectively corresponding to the M ranges; and
outputting, from the classifier, any of K types of predetermined traveling situation categories respectively indicating traveling situations of the vehicle, as a situation estimation result indicating the traveling situation of the vehicle in the traveling section, K being an integer of two or more.

2. The method according to claim 1, wherein:
the classifier specifies a representative vector closest to a vector constituted by the M frequency values from among K representative vectors respectively associated with the K types of traveling situation categories; and
the classifier outputs the traveling situation category corresponding to the specified representative vector.

3. The method according to claim 1, comprising changing the traveling section in accordance with manipulation of a user of the vehicle.

4. The method according to claim 1, wherein the sensor values include a rotational frequency of an engine mounted on the vehicle, acceleration of the vehicle in a left-right direction, a pitch rate of the vehicle, or a steering angle of the vehicle.

5. The method according to claim 1, comprising:
associating the output traveling situation category with the traveling section and storing the traveling situation category and the traveling section; and
displaying a traveling course including the traveling section on a display such that the traveling situation category associated with the traveling section is identifiable.

6. A method of generating a classifier that estimates a traveling situation of a vehicle,
the method comprising:
making a vehicle including at least one sensor travel X traveling sections, X being an integer of two or more;
receiving sensor values, obtained by the at least one sensor, plural times while the vehicle is traveling each traveling section;
specifying which of predetermined M ranges each of the received sensor values belongs to, M being an integer of two or more;
counting, as frequency values, the numbers of times of the execution of the specifying step for the respective ranges; and
generating, as at least a part of a learning data set, data indicating X vectors respectively corresponding to the X traveling sections, each vector being constituted by the M frequency values.

7. The method according to claim 6, comprising after the learning data set is generated, classifying the X vectors of the learning data set into K clusters by k-means and generating K representative vectors, K being an integer of two or more.

8. The method according to claim 7, comprising after the K representative vectors are generated, respectively associating the K representative vectors with K types of traveling situation categories.

9. The method according to claim 8, comprising generating a classifier that:
receives the M frequency values based on the at least one sensor mounted on the vehicle;
specifies which of the K representative vectors the vector constituted by the input M frequency values is related to; and
outputs the traveling situation category associated with the specified representative vector.

10. The method according to claim 1, wherein the vehicle is an all terrain vehicle.

11. The method according to claim 1, wherein:
the traveling situation category denotes a type of an area where the vehicle travels; and
the K types of traveling situation categories include a desert area, a sand dune area, or a rock area.

12. The method according to claim 1, comprising:
transmitting the output situation estimation result from the vehicle to a server; and
storing the received situation estimation result in the server.

13. An estimator that estimates a traveling situation of a vehicle,
the estimator comprising:
a memory storing a computer program; and
the at least one processor electrically connected to the memory, wherein
the at least one processor executes the computer program to realize the method according to claim 1.
